(19) United States
(12) Patent Application Publication
(10) Pub. No.: US 2004/0267872 A1
(43) Pub. Date: Dec. 30, 2004

(54) Provisioning interface

(76) Inventors: Frank Stephen Serdy JR., Sammamish, WA (US); Zankar Thakkar, Redmond, WA (US); John James Ostlund, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 10/610,025

(22) Filed: Jun. 30, 2003

(51) Int. Cl. G06F 15/16

(52) U.S. Cl. 709/200

(57) ABSTRACT

The present invention provides a provisioning interface between a plurality of wireless communication carriers and a mobile data service provider, which allows carrier specific business logic to be executed at the provider. This is especially useful when managing account information that identifies which of the provider's services are available to each of the plurality of carriers' individual users. A request handler receives a request from the carrier and processes the request to generate a work item, which is then stored for future processing. A request processor can then retrieve the work item, determine an appropriate task processor, and pass the work item to the appropriate task processor for processing. Finally, a task processor is provided that processes one or more tasks associated with the work item in accordance with the carrier's business logic stored in a business logic store.

### CROSS-REFERENCE TO RELATED APPLICATIONS

N/A

### BACKGROUND OF THE INVENTION

1. The Field of the Invention

The present invention generally relates to a provisioning interface in a business-to-business environment. More particularly, the present invention allows a wireless communication carrier to manage account information for a data service provider using the carrier's own business module or rules.

2. Background and Relevant Art

In today's ever growing and competitive business industry, more and more business are outsourcing overlapping areas of commercial services to other business. For example, the wireless communication industry has recently been expanded by increasing the types of services that can be provided. Features such as, Web access, instant messaging, e-mail messaging, stock and sport reports, and other such services are now commonly provided to wireless users. Wireless communication carriers (“carriers”), i.e., the companies that own and operate the equipment that transmit signals to and from cellular devices, may supply only the basic wireless service plan. In particular, the carrier will typically sell the connection and minutes that the user can actually use the wireless device, such as pre-paid service, wide area or local area service, emergency service, etc. For economic reasons, however, the carrier will commonly contract out the additional features mentioned above, such as e-mail, Web access, etc. to mobile data service providers (“providers”).

Because the carrier and provider are both servicing the wireless user with different features, they typically share or exchange information about the user in this business-to-business environment. For example, as illustrated in FIG. 1, a Carrier Network Operator 100 and a Mobile Data Service Provider 105 may both maintain information about a user in User Information/Accounts database 110 and User Accounts database 115, respectively. The user account information stored may include such information as the user's identification or phone number, billing information, the services provided, the feature plan, etc.

Information about a user is dynamic in nature, meaning that the information may be continuously changed. Accordingly, if the information about a user's services in one database changes the partner database should also be updated to reflect these changes. For example, if the Carrier 100 is servicing a user under a pre-paid plan that has expired, the Provider's User Account information 115 should be updated to disable data services provided to the user.

There are many other reasons for changing and managing the information about a user's account, and typically these modifications originate from Carrier 100. For example, as shown in list 120, the user may cancel service with the carrier, or there may be an area code split in which case multiple user accounts may need to be updated. Other service updates may include the signup for data service through the carrier. That is, when the user first signs up for carrier services, the user may indicate at that time that they wish to obtain data services. Further, other feature plan changes or other reasons may provide for a modification in the user account information.

In any event, the current process of creating and updating account information originating from Carrier 100 is a tedious and burdensome problem. For example, if Carrier 100 implements a change to User Information 110, such as an account cancellation, they usually have to contact Provider 105 directly and have provider 105 manually update their User Account Information 115. Some systems allow Carrier 100 some form of provisioning interface to implement some of the changes 120 by using a User Tool 125. User Tool 125 may allow the carrier (or user) access to certain User Account Information 115 at the Provider 105 side (usually over an internet connection). This process, however, is an interactive process and allows for updating only one account at a time. Accordingly, someone usually needs to input the information and multiple updates cannot be performed by a batch process.

Another drawback of current provisioning interface systems is that there is no extensible and easy way for a carrier to automatically implement their business rules for managing account information. For example, when a user signs up for both wireless and data services, there may be certain information that the carrier may or may not want the data service provider to ask the user. Further, there may be certain standard service settings that the carrier would like to modify. For example, the provider's standard filtration for junk e-mail may be set to allow only e-mail from people in the user's address book. A carrier, however, may think that this is too restrictive and want the junk e-mail restriction simply set to “high.” As one of ordinary skill in the art would recognize, there may be other business rules and implementations that the carrier may wish to apply. The problem remains, however, for the provider to derive a solution that is capable of retaining a core standardized offering that can be easily integrated and extended to the custom requirements imposed by the carrier interfaces and business rules.

Still yet another drawback of current provisioning interfaces is seen from the perspective of the data service provider in attempting to deliver homogeneous data services in the heterogeneous wireless network industry. More particularly, the data service provider will typically supply services to multiple carriers, each carrier desiring services to be supplied in accordance with their own business models. Currently, however, there is no extensible provisioning platform that enables economies of scale where a standard set of services is readily adapted and deployed by multiple carrier operators.

Accordingly, there exists a need for an extensible and easily integrated provisioning interface system that allows a wireless communication carrier to implement their business rules at the data service provider when managing account information. Similarly, there exists a need for an extensible and deployable platform that significantly reduces the complex and costly integration barrier that currently exists between data service provider and carrier operator.

### BRIEF SUMMARY OF THE INVENTION

In accordance with exemplary embodiments of the present invention, the above-identified deficiencies and drawbacks of current provisioning interface systems are overcome. For example, the present invention provides for a provisioning system in a business-to-business environment between a plurality of wireless communication carriers and a data service provider. Among other things, the provisioning system allows carrier specific business logic to be executed at the provider when managing account information that identifies which of the provider's services are available to each of the plurality of carriers' individual users.

For example, the provisioning system provides for a request handler, supporting several protocols, for receiving a request from a carrier and processing the request to generate a work item. A work item store is also provided that receives and stores the work item for future processing. A request processor can then retrieve the work item from the work item store, determine an appropriate task processor for processing the work item and pass the work item to the appropriate task processor. Further, a business logic store is provided that stores carrier specific business logic for each of the plurality of carriers. Finally, a task processor for receiving the work item is provided. The task processor process one or more tasks associated with the work item in accordance with the carrier's specific business logic that is stored in the business logic store.

In accordance with another example embodiment of the present invention, a computer program product and method are provided that allows carrier specific business logic to be executed at the provider when managing account information that identifies which of the provider's services are available to each of the plurality of carriers' individual users. The system provides for receiving a request, which can be formatted in accordance with one or more protocols, from the carrier and processing the request to generate a work item. The work item can be added to a store for future processing. The work item may then be retrieved from the store and an appropriate task processor can then be determined and selected for processing the work item. The carrier's specific business logic may then be retrieved from a business logic store comprising carrier specific business logic for each o the plurality of carriers. The work item can then be passed to the appropriate task process, whereupon the carrier's specific business logic can be applied in processing the tasks associated with the work item.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example exchange of user account information between a carrier network operator and a mobile data service provider;

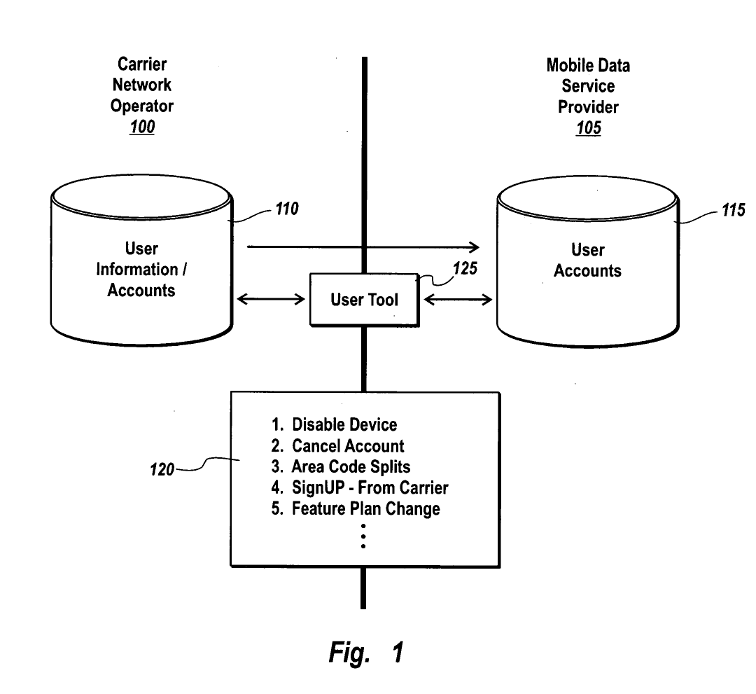

FIG. 2 illustrates a mobile provisioning system in accordance with example embodiments;

FIG. 3 illustrates example acts and steps for computer program products and methods for allowing a carrier to implement business logic at the provider in accordance with exemplary embodiments;

FIG. 4 illustrates the example components of a provisioning system in accordance with exemplary embodiments; and

FIG. 5 illustrates an example system that provides a suitable operating environment for the present invention.

### DETAILED DESCRIPTION OF THE PREFERRED EMBODIMENTS

The present invention extends to both methods and systems for a provisioning interface between a wireless communication carrier (“carrier”) and a data service provider (“provider”) in a business-to-business environment. The embodiments of the present invention may comprise a special purpose or general-purpose computer including various computer hardware, as discussed in greater detail below.

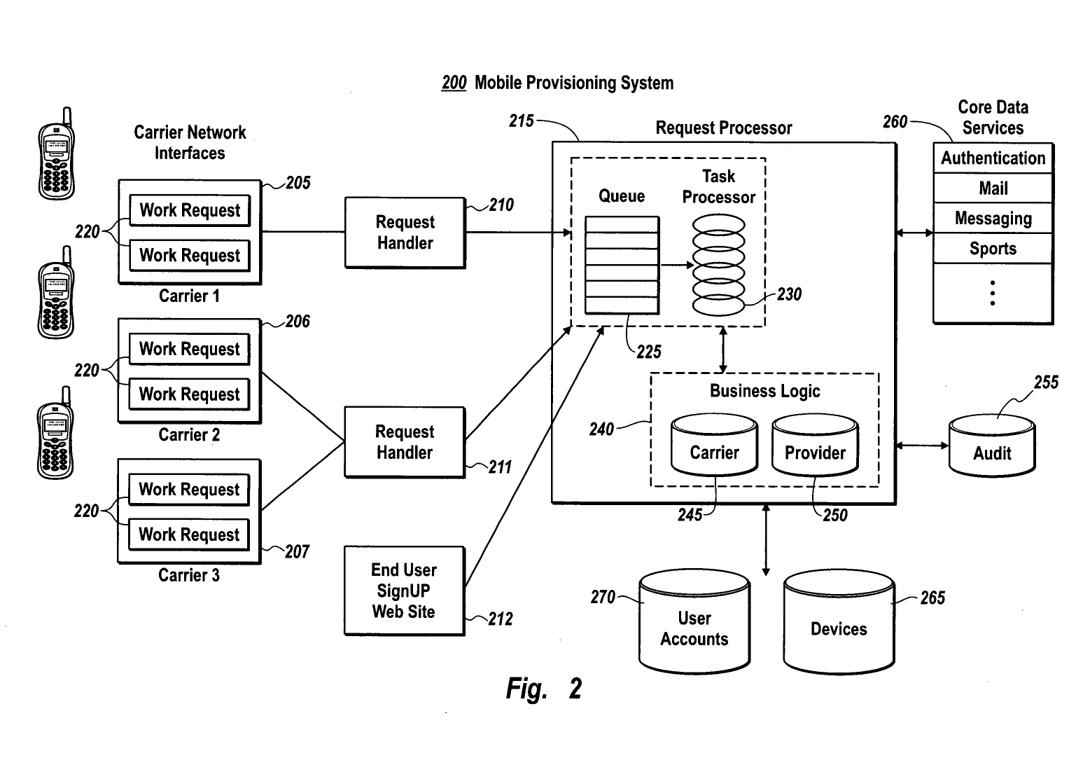

FIG. 2 illustrates a high level representation of a Mobile Provisioning System 200 between a carrier and a provider in accordance with example embodiments. Various Carrier Network Interfaces 205, 206 and 207 are provided for Carriers 1, 2 and 3, respectively. When a carrier wishes to manage user account information on the provider's system (i.e., to create or update a user account for a user that is common to both the carrier and provider) Work Requests 220 can be made over any one of the Carrier Network Interfaces 205, 206 and 207. A Work Request 220 may contain any form of requests to, e.g., disable a user device, cancel a data service account, provide for area code splits, signup a user from the carrier, provide a feature change plan, request billing information, or request any other type of information and/or modification of user account information.

Although a Work Request 220 originates from the carrier, user interaction can trigger the carrier to send Work Request 220 on behalf of the user when the user purchases the device. For example, when a user purchases a device and signs up for service from the carrier, the device may be used to authenticate and authorize the user to utilize the services of the provider. The authorization code will typically be sent to the user's device, whereupon she can authenticate and begin using the provider's services.

Each Work Request 220 may represent a single request of the above-identified types of request; however, a single Work Request 220 may also include a combination of any of the above-identified types of requests. Further, another embodiment provides that a single Work Request 220 may include multiple instances (sub-requests) of a request. For example, an area code split usually affects multiple users. Accordingly, example embodiments provide for allowing batch processing of multiple requests within a single Work Request 220. Because batch request are typically large data processing units, the provider may want to do the requests incrementally; and therefore, batch requests may be handled asynchronously. On the other hand, single requests within a Work Request 220 are handled interactively because single requests are typically on demand services, e.g., a user will want to have service as soon as they signup. The details of how these and other types of requests are prioritized are discussed in greater detail below with regard Queue 225.

Other example embodiments may handle large batch request through a throttling mechanism. For example, if the incoming request has more than a maximum allowable number of sub-requests, the request may be discarded. The maximum limit may be a default setting for all carriers, which can be extended to have a different limit per carrier.

Each Work Request 220 is received by a Request Handler 210 or 211 using one or more protocols over various transports. For example, preferred embodiments provide that Work Request 220 may be transported using Simple Object Access Protocol (“SOAP”) over a HyperText Transfer Protocol (HTTP) transport connection. As one of ordinary sill in the art would appreciate, SOAP is based on the eXtensible Markup Language (XML), which is a markup language for structuring, storing and sending data. SOAP provides a way to communicate between applications running on different operating systems, with different technologies and programming languages. Accordingly, SOAP is platform and language agnostic, yet simple and extensible. As such, some embodiments of the present invention prefer using SOAP in implementing the sending of Work Requests over the Carrier Network Interfaces 205, 206 or 207.

The present invention; however, is extensible in that it is not limited to a single protocol for transferring Work Requests 220 from Carrier Network Interfaces 205, 206, and 207. For example, in accordance with one embodiment there may be multiple individual Request Handlers, e.g., 210, that are designed for handling Work Requests 220 over a single transport protocol from multiple individual Carriers, e.g., 205, respectively. In other words, a single Request Handler 210 may be provided for a single Carrier 205 transferring Work Requests 220 over a single transport protocol. In accordance with other exemplary embodiments, a single Request Handler, e.g., 211, may be able to handle multiple protocols from multiple Carriers, e.g., 206 and 207. Accordingly, the one or more Request Handlers 210 and 211 implement extensible interfaces that enable the carrier to integrate data services and manage associated accounts within the constraints of their unique business rules and technologies.

Regardless of the protocol used to transport a Work Request 220, once the Work Request is received by the Request Handlers 210 and 211, example embodiments provide that the Request Handlers 210 and 211 can generate a work item (not shown) that is representative of the corresponding Work Request 220. The work items are then transferred to Queue 225 in the Request Processor 215 for prioritization and processing. In accordance with other example embodiments, an end user may signup for services directly with the provider using the End User Signup Web Site 212. In such case, the user will supply the provider with information sufficient to process the signup request in accordance with the carrier's business rules (as discussed in greater detail below). Accordingly, the Web site will transfer a work item to the Queue 225 within the Request Processor 215, which is also prioritized and subsequently processed just like other Work Requests 220 received from carriers.

As one of ordinary skill in the art would recognize Queue 225 is simply a storage device for a sequence of work items that are waiting to be processed. The work items can be prioritized in accordance with any number of factors such as: the source of each queued item, how frequently items arrive on the queue, how long they can or should wait, whether some items should jump a head in the queue, how multiple queues might be formed and managed, and the rules by which items are enqueued and dequeued. A simple example of prioritization of work items was given above regarding single requests and batch requests, wherein a single request will typically take priority over a large batch request process. Other embodiments shield spikes in demand by providing for multiple Queues 225 for storing specific types of work items. For example, there may be a Queue 225 for storing and prioritizing single work items, and a separate Queue 225 for storing and prioritizing batch work items.

Once a work item is stored and ready for processing, the Request Processor 215 can retrieve the work item from Queue 225 and determine an appropriate Task Processor 230 for processing the work item. The Task Processor 230 may be selected on the basis of the type of device used, the carrier, the data services provided, etc. This information should be information provided from the user or the carrier, and such information may be stored, e.g., in the Devices Database 265, Core Data Services List 260, or elsewhere.

The work item can then be passed to the Task Processor 230, whereupon the work item is divided into a serious of tasks each of which can be independently processed to complete the over all work item request. In other words, the work item is a list of tasks, which can be strung together and executed. This feature provides for a system with retry capabilities. For example, exemplary embodiments provide that the Request Processor 215 can load the work item into Task Processor 230 as a provisional request and the sequence of tacks associated therewith can be executed one by one. If one task fails, then either one of two processes may be implemented for retry. First, if the tasks should be implemented in sequential order, then the failed tasks and any remaining tasks can be dropped back into Queue 225 and retried at some later period in time, e.g., five minutes. Alternatively, if the tasks can be executed in any order, the remaining tasks may be completed and only the failed task would be put back into Queue 225 for future processing by Task Processor 230. In either event, the work item as a whole will not need to be reprocessed. This process can be repeated any number of times, and other exemplary embodiments allow for a back-off of retry period if the task or tasks continually fail, e.g., after seven attempts the retry period can be backed-off from 5 to 15 minutes. After a configurable number of retries, an error may be returned to the carrier/user and no further attempts to retry the work item made.

This retry feature and queuing system provides for a robust system with a reliable and secure processing implementation that inherently manages the complex operational challenges of integrating sensitive business transactions and information over a transient and unreliable network. For example, a task may be contingent on the availability of an external partner's system being operational, e.g., when migrating users from one provider to another. If the partner's system is down, e.g., maintenance, firewall problems, etc., the present invention allows a provider the ability to do all other tasks associated with a work item that do not require the use of the external partners system, and then continually retry only those tasks associated with the external partner's system. As previously stated, the failed tasks can be retried any number of times with a back-off option to conserve processing resources.

In accordance with yet another example embodiment, the work items processed by Task Processor 230 are executed in accordance with a carrier's specific business rules. For example, as described above, a carrier may have certain requirements for how the individual tasks within a work item are to be executed, such as setting up e-mail filtering, how the provider is to directly interact with the user, the types of questions a provider may ask a user, whether the user identification is sent directly to the user's device or sent to the carrier, etc. The present invention allows the provider to support various standard features, which the carrier can call to execute a work item in accordance with their own business desires. This allows the carrier total control over how the user will interact with the provider, if at all. Further, this allows the carrier great flexibility in controlling the user's experience and with providing their customers with what they consider the best possible service. Moreover, it allows for the carrier to define their unique interface, schema extensions, provisioning extensions, custom business modules, etc. In addition, the provider is alleviated of the burden for writing custom solutions for various carrier problems and concerns.

A Business Logic Store 240 is provided that may include the Carrier Logic 245 and Provider Logic 250. The Carrier Logic 245 may include a unique carrier interface, site identification, carrier identification, schema extensions, provisioning extensions, custom business modules (rules), etc. The Carrier Logic 245 can be stored on a per carrier basis, such that when a work item is processed by Task Processor 230, the Carrier Logic 245 associated with that particular carrier and their particular Carrier Logic 245 can be retrieved. The individual tasks associated with a carrier work item may then be processed in accordance with the carrier's desires and business rules as set forth in the business module within the Carrier Logic 245. Accordingly, the provider supplies the basic tools or features, such as an application programming interface, that the carrier can call to implement their unique business logic.

As one of ordinary skill in the art would recognize, however, there are core standard procedures or offerings that the provider typically implements for certain Work Requests 220. Accordingly, Provider Logic 250 is also supported that may implement any number of standard processes. For example, when setting up a new user e-mail account, the provider will typically set up a user account in User Accounts database 270 and send a welcome message. These procedures will typically be performed in accordance with the provider's requirements, and therefore the carrier's Business Logic 245 should not be involved in these types of processes. Nevertheless, most tasks for various work items are customizable by the carrier in accordance with their own business module or rules as specified within the Carrier Logic 245.

In still yet another example embodiment, an Auditor 255 is provided that may trace actions performed by the Task Processor 230 and what carrier or carriers where involved in the transaction. For example, if a carrier is setting up a new account or managing existing accounts, Auditor 255 can monitor and record all transactions in which the carrier was involved for trouble shooting and other diagnostic purposes.

The present invention also provides for a mapping feature (not shown) that will map the provider's user identification (ID) with the carrier's user ID. Typically, the provider's user ID will not be the same as the carrier's. For example, the carrier's ID for a user may be the wireless phone number of the user, while the provider's user ID may be some other form of identification. In any event, this feature allows an additional level of shielding user information for those carriers who do not want the provider to have any interaction with the user. For example, instead of supplying the provider with specific account information such as address and phone number, the carrier may simply give the provider an account number and the carrier will take care of all billing and other interaction with the user. The mapping feature allows a way for the provider to keep track of user information on a per carrier basis, while maintaining their own organized system for retrieving user information. Further, the mapping feature in combination with the support of the carrier's specific business logic modules provides a flexible underlying platform. These interfaces enable the service provider to easily extend and adapt the data services as new services are introduced or as data requirements change in the carrier's business modules.

Another security feature provided by the present invention allows for limited access to user information such that only those portions of user information that are associated with a particular carrier are accessible by that carrier. For example, when a carrier sends a Work Request 220 over a Carrier Network Interface 205, 206 or 207, example embodiments provide for a secure way to verify the credentials of a carrier such as through the use of any one of a number of encryption techniques well known in the art. Once verified, the system may provide that only those portions of user and business logic associated with that carrier can be accessed.

The present invention may also be described in terms of methods comprising functional steps and/or non-functional acts. The following is a description of acts and steps that may be performed in practicing the present invention. Usually, functional steps describe the invention in terms of results that are accomplished, whereas non-functional acts describe more specific actions for achieving a particular result. Although the functional steps and non-functional acts may be described or claimed in a particular order, the present invention is not necessarily limited t any particular ordering or combination of acts and/or steps.

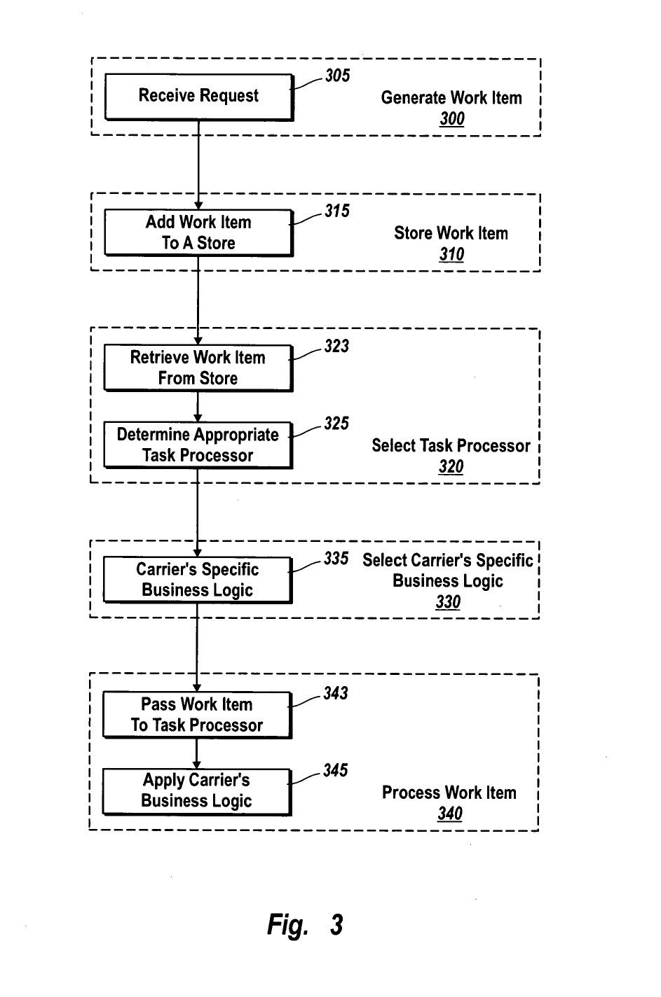

FIG. 3 illustrates example steps and acts used in assisting the execution of carrier specific business logic at the provider when managing account information that identifies which of the provider's services are available to each of a plurality of carriers' users. For example, a step for Generating 300 a work item may include the act of Receiving 305 a request from the carrier and processing the request. The request may be formatted in accordance with any one of a number of protocols. For example, exemplary embodiments provided that the request may be formatted as a SOAP message and sent over an HTIP transport.

A step for Storing 310 the work item generated may include the act of Adding 315 the work item to a store for future processing. The store could be a queue that includes other work items in addition to the generated work item. As previously discussed, the work items may be prioritized based on any number of criteria as specified by the provider. For example, the work items that are a single request may have priority over work items that are a large batch process. Further, the present invention provides for multiple stores or queues to combat against spikes in demand.

A step for Selecting 320 an appropriate task processor for processing the work item may include the acts of Retrieving 323 the work item from the store and Determining 325 the appropriate task processor. The appropriate task processor may be determined based on any number of factors including the carrier, the type of device used, the data services requested, etc.

A step for Selecting 330 the carrier's specific business logic may include the act of Retrieving 335 the carrier's specific business logic from a business logic store. The business logic store will typically include specific business logic for the plurality of carriers supported by the provisioning system.

Finally, a step for Processing 340 the work item at the appropriate task process may include the acts of Passing 343 the work item to the task processor and Applying 345 the carrier's specific business logic when processing the work item. As mentioned above, the carrier's specific business logic is determined from a supply of standardized features for various tasks, which the provider strings together to be called in implement the carrier's desired business module or rules.

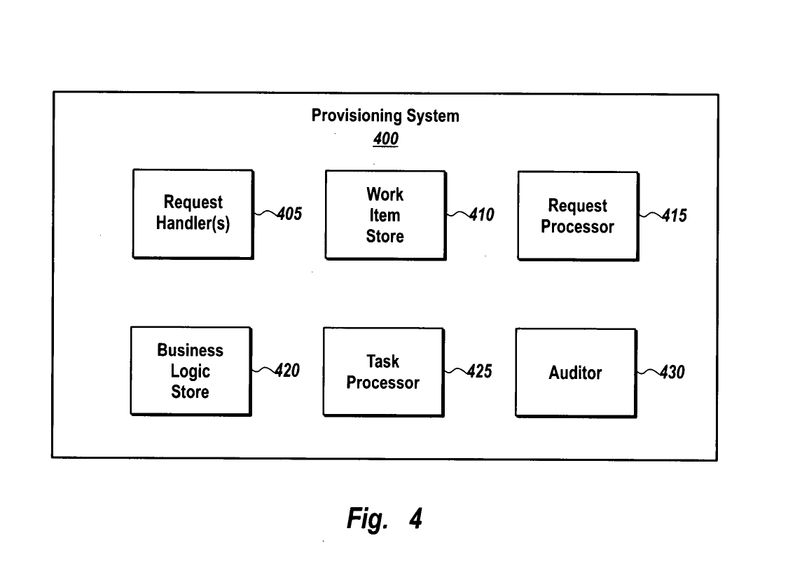

FIG. 4 illustrates the basic components of a provisioning system in accordance with example embodiments. For example, one or more Request Handlers 405 are provided for receiving a request from the carrier and processing the request to generate a work item. The Request Handlers 405 may support one or more request protocols, such as a SOAP message sent over an HTTP protocol.

A Work Item Store 410 is also provided for receiving the work item from the one or more Request Handlers 405 and storing the work item for processing. The Work Item Store 410 may be a queue as described above with regard to other example embodiments, or some other form of data store.

A Request Processor 415 may also provided for retrieving the work item form the Work Item Store 410, determining an appropriate task processor for processing the work item and then passing the work item to the appropriate task processor. Again, as mentioned previously, the task processor selected may be based on any number of factors including the type of device, the carrier, the services requested by the user, etc.

A Business Logic Store 420 can also be provided that stores carrier specific business logic for each of the plurality of carriers. The Business Logic Store 420 may also include provider's standardized logic for implementing standard processes for executing work items in accordance with example embodiments described above.

A Task Processor 425 may also be provided for receiving the work item and processing one or more tasks associated therewith in accordance with the carrier's specific business logic stored in the Business Logic Store 420 and the provider's core standardized procedures or offerings. The Task Processor 425 can process tasks independent of one another to provide for the example retry feature described above.

Finally, an Auditor 430 may be provided that monitors all activity from the Task Processor 425. The auditor 430 may have the capability of tracing specific activity from a carrier in managing user account information back to that particular carrier, date, time and event modified for trouble shooting purposes.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

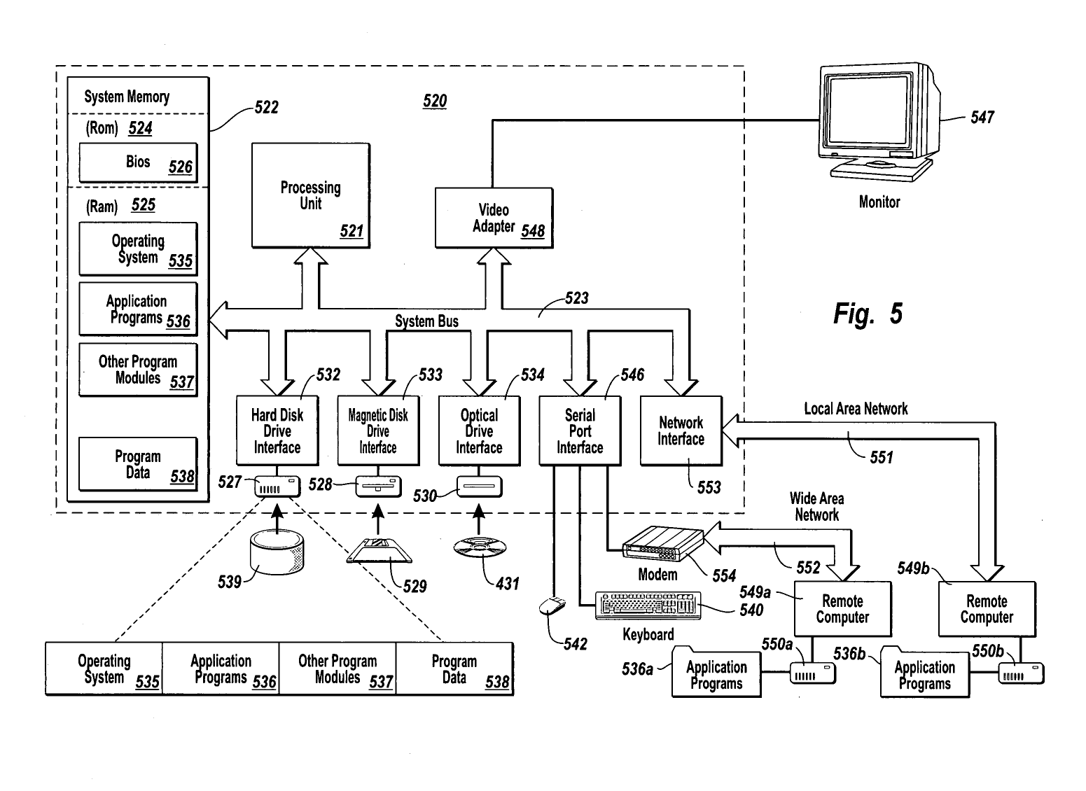

FIG. 5 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an exemplary system for implementing the invention includes a general purpose computing device in the form of a conventional computer 520, including a processing unit 521, a system memory 522, and a system bus 523 that couples various system components including the system memory 522 to the processing unit 521. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disk drive 530 for reading from or writing to removable optical disk 531 such as a CD-ROM or other optical media. The magnetic hard disk drive 527, magnetic disk drive 528, and optical disk drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disk 531, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 539, magnetic disk 529, optical disk 531, ROM 524 or RAM 525, including an operating system 535, one or more application programs 536, other program modules 537, and program data 538. A client may enter commands and information into the computer 520 through keyboard 540, pointing device 542, or other input devices (not shown), such as a microphone, joy stick, game pad, satellite dish, scanner, or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 is connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a business-to-business environment between a plurality of wireless communication carriers and a data service provider, a provisioning system that allows carrier specific business logic to be executed at the provider when managing account information that identifies which of the provider's services are available to each of the plurality of carriers' individual users, the provisioning system comprising:
one or more request handlers, that support one or more request protocols, for receiving a request from a carrier and processing the request to generate a work item;
a work item store for receiving the work item from the one or more request handlers and storing the work item for future processing;
a request processor for retrieving the work item from the work item store, determining an appropriate task processor for processing the work item, and then passing the work item to the appropriate task processor;
a business logic store that stores carrier specific business logic for each of the plurality of carriers; and
a task processor for receiving the work item and processing one or more tasks associated therewith in accordance with the carrier's specific business logic that is stored in the business logic store.

2. The provisioning system of claim 1, wherein each of the one or more tasks associated with the work item can be independently processed by the task processor such that if one task fails it can be retried without having to retry all of the other one or more tasks associated with a work item.

3. The provisioning system of claim 2, wherein the processing of a failed task is retried after a predetermined time period has elapsed, and wherein the predetermined time period can be adjusted after a predetermined number of retry attempts for the failed task.

4. The provisioning system of claim 1, wherein the business logic store further stores business logic implemented by the provider also for use in processing the work item.

5. The provisioning system of claim 1, wherein the one or more request protocols comprise a SOAP message sent over an HTTP connection.

6. The provisioning system of claim 1, wherein the request comprises a user signup.

7. The provisioning system of claim 1, wherein the work item store is a queue comprising other work items, and wherein the work item and other work items are prioritized in accordance with one or more criteria.

8. The provisioning system of claim 7, wherein the criteria comprises the source of each queued item.

9. The provisioning system of claim 1, further comprising:
an auditor for monitoring and recording at least one of a work item processed by the task processor, the carrier, a date or a time.

10. The provisioning system of claim 1, wherein the carrier is allowed access to only those portions of the users accounts that are common to both the carrier and the provider.

11. The provisioning system of claim 1, further comprising:
a security component for verifying the carrier's credentials prior to receiving the request from the one or more request handlers.

12. The provisioning system of claim 1, wherein the business logic comprises a unique carrier interface.

13. In a business-to-business environment between a plurality of wireless communication carriers and a data service provider, a method that allows carrier specific business logic to be executed at the provider when managing account information that identifies which of the provider's services are available to each of the plurality of carriers' individual users, the method comprising acts of:
receiving a request, formatted in accordance with any of one of a plurality of protocols, from the carrier and processing the request to generate a work item;
adding the work item to a store for future processing;
retrieving the work item from the store;
determining an appropriate task processor to select for processing the work item;
retrieving the carrier's specific business logic from a business logic store comprising carrier specific business logic for each of the plurality of carriers;
passing the work item to the appropriate task processor; and
applying the carrier's specific business logic to process the work item.

14. The method of claim 13, wherein the work item store is a queue comprising other work items, and wherein the work item and other work items are prioritized in accordance with one or more criteria.

15. The method of claim 14, further comprising the acts of:
failing to process a task within the work item;
adding the failed task back to the queue for future processing;
retrying to process the task without having to retry other successful tasks within the work item.

16. The method of claim 14, wherein the criteria comprises how frequently items arrive on the queue.

17. The method of claim 13, wherein the request comprises a batch request.

18. The provisioning system of claim 13, wherein the business logic comprises custom business modules.

19. The method of claim 13, wherein the business logic store further stores business logic implemented by the provider also for use in processing the work item.

20. The method of claim 13, wherein the one or more request protocols comprise a SOAP message sent over an HTTP connection.

21. The method of claim 13, wherein the request comprises a service cancellation.

22. In a business-to-business environment between a plurality of wireless communication carriers and a data service provider, a method that allows carrier specific business logic to be executed at the provider when managing account information that identifies which of the provider's services are available to each of the plurality of carriers' individual users, the method comprising steps for:
generating a work item, formatted in accordance with any of one of a plurality of protocols, from a request received from the carrier;
storing the work item for future processing;
selecting an appropriate task processor to process the work item;
selecting the carrier's specific business logic from a business logic store comprising carrier specific business logic for each of the plurality of carriers; and
processing the work item at the appropriate task processor in accordance with the carrier's specific business logic.

23. The method of claim 22, wherein the work item store is a queue comprising other work items, and wherein the work item and other work items are prioritized in accordance with one or more criteria.

24. The method of claim 23, wherein the criteria comprises how long they can or should wait.

25. The method of claim 22, wherein the request comprises a batch request.

26. The method of claim 23, wherein the work item comprises a plurality of tasks, each of which can be independently processed by the task processor such that if one task fails it can be retried without having to retry all tasks associated with a work item.

27. The method of claim 26, wherein the processing of a failed task is retried after a predetermined time period has elapsed, and wherein the predetermined time period can be adjusted after a predetermined number of retry attempts for the failed task.

28. The method of claim 22, wherein the business logic store further stores business logic implemented by the provider also for use in processing the work item.

29. The method of claim 22, wherein the one or more request protocols comprise a SOAP message sent over an HTIP connection.

30. The method of claim 22, wherein the request comprises a user account modification.

31. The method of claim 22, further comprising a step for:
mapping a carrier's user identification with a provider's user identification, wherein the carrier's user identification is different from the provider's user identification.

32. The provisioning system of claim 22, wherein the business logic comprises carrier identification.

33. In a business-to-business environment between a plurality of wireless communication carriers and a data service provider, a computer readable media carrying computer executable instructions that implement a method for allowing carrier specific business logic to be executed at the provider when managing account information that identifies which of the provider's services are available to each of the plurality of carriers' individual users, the method comprising acts of:
receiving a request, formatted in accordance with any of one of a plurality of protocols, from the carrier and processing the request to generate a work item;
adding the work item to a store for future processing;
retrieving the work item from the store;
determining an appropriate task processor to select for processing the work item;
retrieving the carrier's specific business logic from a business logic store comprising carrier specific business logic for each of the plurality of carriers;
passing the work item to the appropriate task processor; and
applying the carrier's specific business logic to process the work item.

34. The method of claim 33, further comprising the acts of:
failing to process a task within the work item;
adding the failed task back to the queue for future processing;
retrying to process the failed task without having to retry other successful tasks within the work item.

35. The method of claim 33, wherein the business logic store further stores business logic implemented by the provider also for use in processing the work item.

36. The method of claim 33, wherein the one or more request protocols comprise a SOAP message sent over an HTTP connection.

37. The method of claim 33, wherein the request comprises a disable device request.

38. The method of claim 33, wherein the work item store is a queue comprising other work items, and wherein the work item and other work items are prioritized in accordance with one or more criteria.

39. The method of claim 38, wherein the criteria comprises whether some items should jump a head in the queue.

40. The provisioning system of claim 33, wherein the business logic comprises schema extensions.

41. In a business-to-business environment between a plurality of wireless communication carriers and a data service provider, a computer readable media carrying computer executable instructions that implement a method for allowing carrier specific business logic to be executed at the provider when managing account information that identifies which of the provider's services are available to each of the plurality of carriers' individual users, the method comprising steps for:
generating a work item using one or more request handlers, that support one or more request protocols, from a request received from the carrier;
storing the work item in a work item store for future processing;
selecting by a request processor an appropriate task processor to process the work item;
selecting by the request processor the carrier's specific business logic from a business logic store comprising carrier specific business logic for each of the plurality of carriers; and
processing the work item at the appropriate task processor in accordance with the carrier's specific business logic.

42. The method of claim 41, wherein the step for processing further comprising the acts of:
failing to process a task within the work item;
adding the failed task back to the queue for future processing;
retrying to process the failed task without having to retry other successful tasks within the work item.

43. The method of claim 41, wherein the business logic store further stores business logic implemented by the provider also for use in processing the work item.

44. The method of claim 41, wherein the one or more request protocols comprise a SOAP message sent over an HTTP connection.

45. The method of claim 41, wherein the request comprises an area code split or a feature plan change.

46. The method of claim 41, wherein the work item store is a queue comprising other work items, and wherein the work item and other work items are prioritized in accordance with one or more criteria.

47. The method of claim 46, wherein the criteria comprises the source of each queued item, how frequently items arrive on the queue, how long they can or should wait, whether some items should jump a head in the queue, how multiple queues might be formed and managed, and the rules by which items are enqueued and dequeued.

48. The method of claim 41, further comprising a step for:
mapping a carrier's user identification with a provider's user identification, wherein the carrier's user identification is different from the provider's user identification.

49. The provisioning system of claim 41, wherein the business logic comprises one or more of a unique carrier interface, site identification, carrier identification, schema extensions, provisioning extensions, or custom business modules.
